(19) United States
(12) Patent Application Publication
(10) Pub. No.: US 2014/0198771 A1
(43) Pub. Date: Jul. 17, 2014

(54) BASE STATION, HANDOVER CONTROL METHOD, AND NON-TRANSITORY COMPUTER-READABLE RECORDING MEDIUM

(71) Applicants: Shigeto Suzuki, Osaka-shi (JP); Shinichi Sawada, Osaka-shi (JP); Hirokazu Kobayashi, Osaka-shi (JP); Akio Yoshihara, Osaka-shi (JP); Shumpei Fuse, Osaka-shi (JP)

(72) Inventors: Shigeto Suzuki, Osaka-shi (JP); Shinichi Sawada, Osaka-shi (JP); Hirokazu Kobayashi, Osaka-shi (JP); Akio Yoshihara, Osaka-shi (JP); Shumpei Fuse, Osaka-shi (JP)

(73) Assignee: SHARP KABUSHIKI KAISHA, Osaka-shi, Osaka (JP)

(21) Appl. No.: 14/241,487

(22) PCT Filed: Aug. 29, 2012
(86) PCT No.: PCT/JP2012/071793

§ 371 Date: Feb. 27, 2014

(30) Foreign Application Priority Data
Aug. 31, 2011 (JP) 2011-188580

(51) Int. Cl. H04W 36/16

(52) U.S. Cl. CPC H04W 36/165
USPC 370/331

(57) ABSTRACT

Provided is an HeNB which can cause a mobile station within a coverage of the HeNB to be handed over to another communicable base station. An HeNB communicates with an MME through a relay process by a gateway. The HeNB detects a state of the gateway. The HeNB stops communication with a mobile phone in accordance with the state of the gateway.

### TECHNICAL FIELD

The present invention relates to a base station, a handover control method, and a program. The present invention particularly relates to a base station communicating with an entity performing mobility management by a gateway, a handover control method in the base station, and a program for controlling the base station.

### BACKGROUND ART

Conventionally, many HeNBs (Home eNodeBs) are installed in commercial facilities and the like. For example, an HeNB is installed in each store. In such circumstances, an owner of a mobile station (for example, mobile phone) frequently moves around a commercial facility, and thus the number of handovers is naturally increased.

Thus, in order to prevent a large load from being applied to equipment higher than an indoor base station, a gateway (GW) is installed between an entity performing mobility management (MME: Mobility Management Entity) or the like and an HeNB, as described for example in Japanese Patent Laying-Open No. 2010-213273 (Patent Document 1) and Japanese Patent Laying-Open No. 2010-011110 (Patent Document 2).

### CITATION LIST

### Patent Document

PTD 1: Japanese Patent Laying-Open No. 2010-213273
PTD 2: Japanese Patent Laying-Open No. 2010-011110

### SUMMARY OF INVENTION

### Technical Problem

However, Patent Document 1 and Patent Document 2 do not disclose what operation the HeNB performs when the gateway cannot communicate with the HeNB due to a fault or the like. Thus, a mobile station within a coverage of the HeNB which is under the control of the uncommunicable gateway cannot communicate with another mobile station.

A further detailed description will be given below. Whether or not the mobile station moves to a cell formed by another base station basically depends on communication quality. Thus, as long as the HeNB continues outputting radio waves when the gateway becomes uncommunicable, the mobile station within the coverage of the HeNB cannot be handed over to the cell formed by another base station. Therefore, the mobile station cannot communicate with another mobile station.

The invention of the present application has been made in view of the aforementioned problem, and one object of the present invention is to provide a base station, a handover control method, and a program which enables a mobile station within a coverage of a base station to be handed over to another communicable base station.

### Solution to Problem

According to an aspect of the present invention, a base station communicates with an entity performing mobility management through a relay process by a gateway. The base station includes detection means detecting a state of the gateway, and communication control means stopping communication with a mobile station in accordance with the state of the gateway.

According to another aspect of the present invention, a base station communicates with an entity performing mobility management through a relay process by a gateway. The base station includes detection means detecting a state of the gateway, and transmission control means transmitting, when a fault of the gateway is detected, a command to cause a mobile station to be handed over to a base station which is not under control of the gateway, to the mobile station.

Preferably, the detection means determines that communication with the gateway becomes impossible and the communication control means stops the communication with the mobile station, in a case where a signal transmitted from the gateway at a predetermined cycle cannot be received within a predetermined time longer than the cycle, in a case where a response signal to a request signal transmitted to the gateway cannot be received from the gateway within a predetermined time since transmission of the request signal, or in a case where a signal indicating that the gateway is uncommunicable is received from the gateway. Preferably, the detection means detects the fault of the gateway, on a basis that a signal transmitted from the gateway at a predetermined cycle cannot be received within a predetermined time longer than the cycle, that a response signal to a request signal transmitted to the gateway cannot be received from the gateway within a predetermined time since transmission of the request signal, or that a signal indicating that the gateway is uncommunicable is received from the gateway.

Preferably, the communication control means causes at least one of a process of powering off part or all of components of the base station, a process of stopping transmission of a signal from the base station to the mobile station, and a process of restarting the base station, to be performed.

According to still another aspect of the present invention, a base station communicates with an entity performing mobility management through a relay process by a gateway. The base station includes detection means detecting a state of the gateway, and change means changing an operation mode of the base station, when a fault of the gateway is detected, from a setting in which access of the mobile station is allowed to a setting in which access of the mobile station is barred.

According to still another aspect of the present invention, a handover control method is a handover control method in a base station communicating with an entity performing mobility management through a relay process by a gateway. The handover control method includes the steps of: the base station detecting a state of the gateway; and the base station stopping communication with a mobile station in accordance with the state of the gateway.

According to still another aspect of the present invention, a handover control method is a handover control method in a base station communicating with an entity performing mobility management through a relay process by a gateway. The handover control method includes the steps of: the base station detecting a state of the gateway; and the base station transmitting, when a fault of the gateway is detected, a command to cause a mobile station to be handed over to a base station which is not under control of the gateway, to the mobile station. According to still another aspect of the present invention, a program controls handover in a base station communicating with an entity performing mobility management through a relay process by a gateway. The program causes a processor of the base station to execute the steps of detecting a state of the gateway, and stopping communication with a mobile station in accordance with the state of the gateway.

According to still another aspect of the present invention, a program controls handover in a base station communicating with an entity performing mobility management through a relay process by a gateway. The program causes a processor of the base station to execute the steps of detecting a state of the gateway, and transmitting, when a fault of the gateway is detected, a command to cause a mobile station to be handed over to a base station which is not under control of the gateway, to the mobile station.

### Advantageous Effects of Invention

According to the present invention, a mobile station within a coverage of a base station can be handed over to another communicable base station.

### BRIEF DESCRIPTION OF DRAWINGS

FIG. 1 is a view showing a schematic configuration of a communication system.

FIG. 2 is a functional block diagram of an HeNB.

FIG. 3 is a view showing determination criteria for determining that communication is impossible, process timings, and contents of a predetermined process.

FIG. 4 is a flowchart illustrating a flow of a process of the HeNB.

FIG. 5 is a view showing a typical hardware configuration of the HeNB.

FIG. 6 is a functional block diagram of another HeNB.

FIG. 7 is a view showing determination criteria for determining that communication is impossible, process timings, and contents of a predetermined process.

FIG. 8 is a flowchart illustrating a flow of a process of another HeNB 30.

FIG. 9 is a functional block diagram of still another HeNB.

FIG. 10 is a view showing a configuration of another communication system.

### DESCRIPTION OF EMBODIMENTS

Hereinafter, electronic apparatuses in accordance with embodiments of the present invention will be described with reference to the drawings. In the description below, identical parts will be designated by the same reference numerals. Since their names and functions are also the same, the detailed description thereof will not be repeated.

It is noted that, hereinafter, “handover” means that a mobile station switches a base station to be connected. Further, typically, “handover” means that, when a mobile station moves beyond a cell, connection information is handed over from a base station of the previous cell to a base station of a visited cell such that the mobile station can continue communication. That is, it can also be said that “handover” means that, as a mobile station moves, the mobile station is connected (so-called reconnected) to a base station of a visited cell.

### Embodiment 1

### 1. System Configuration

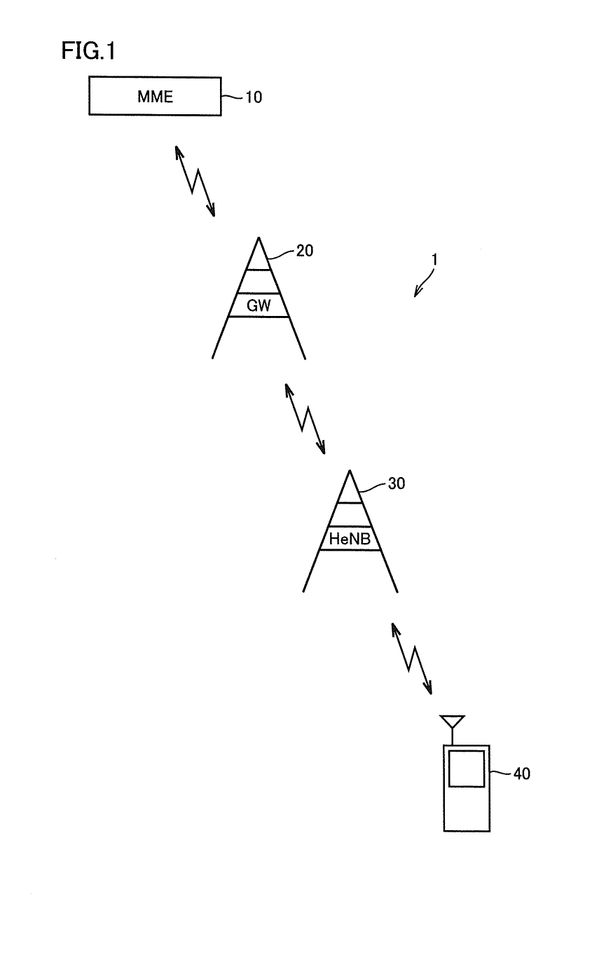

FIG. 1 is a view showing a schematic configuration of a communication system 1 in accordance with the present embodiment. Referring to FIG. 1, communication system 1 includes an MME 10, a gateway 20, an HeNB 30, and a mobile phone 40 as a mobile station (UE).

MME 10 is a node which performs mobility management such as registration of the position of a mobile station, call of the mobile station, and handover of the mobile station between base stations (i.e., mobility management entity). MME 10 communicates with gateway 20.

Gateway 20 is an apparatus which relays data communication between MME 10 and HeNB 30. Gateway 20 transmits a predetermined signal to HeNB 30 at a predetermined cycle Ta. Further, when gateway 20 receives a request signal from HeNB 30, gateway 20 transmits a response signal to the request signal to HeNB 30. Furthermore, gateway 20 transmits various signals to HeNB 30 and MME 10.

HeNB 30 is a wireless base station which manages a femtocell. The HeNB is, for example, an indoor base station. HeNB 30 communicates with mobile phone 40. HeNB 30 also communicates with gateway 20. Specifically, HeNB 30 transmits data transmitted from mobile phone 40, to MME 10, via gateway 20. HeNB 30 transmits data transmitted from MME 10 via gateway 20, to mobile phone 40.

HeNB 30 also performs a process of causing mobile phone 40 to be handed over to another base station such as an HeNB. Specifically, HeNB 30 performs a process of causing mobile phone 40 to be handed over to another base station such as an HeNB which is under the control of HeNB 30.

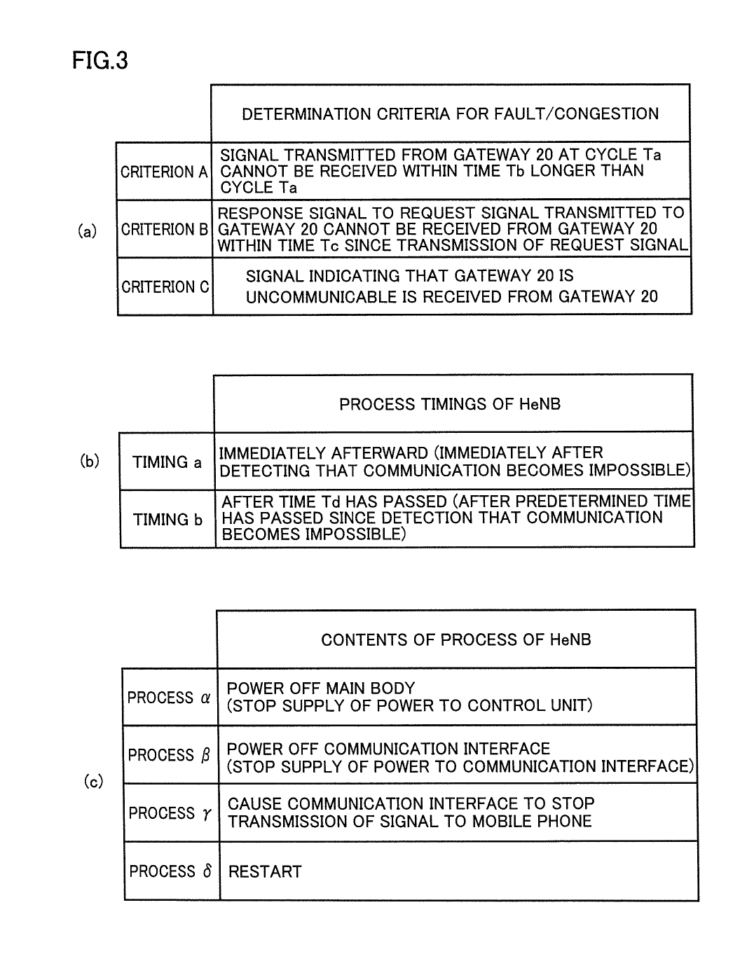

The process of HeNB 30 will be summarized below. HeNB 30 detects that communication with gateway 20 becomes impossible. When HeNB 30 detects that communication with gateway 20 becomes impossible, HeNB 30 performs a predetermined process for causing a mobile station (for example, mobile phone 40) within a coverage of HeNB 30 to be handed over to a base station different from HeNB 30 (for example, another HeNB), as an example, immediately after the detection. Contents of the “predetermined process” will be described later (FIG. 3(c)).

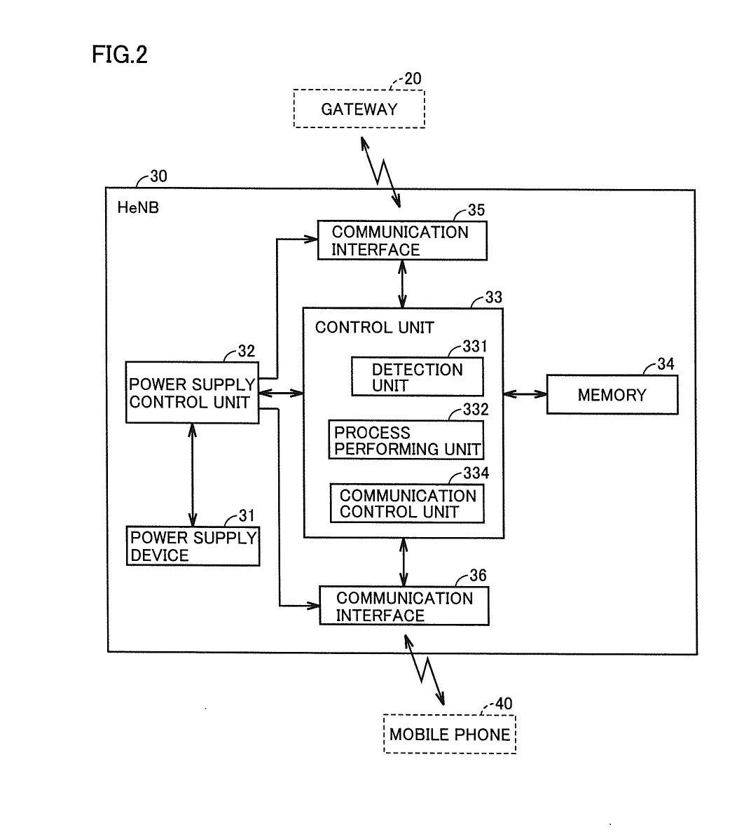

FIG. 2 is a functional block diagram of HeNB 30. Referring to FIG. 2, HeNB 30 includes a power supply 31, a power supply control unit 32, a control unit 33, a memory 34, a communication interface 35, a communication interface 36, and a timer not shown. Control unit 33 includes a detection unit 331, a process performing unit 332, and a communication control unit 334.

Power supply 31 supplies power to control unit 33, memory 34, and communication interfaces 35, 36 via power supply control unit 32. Power supply control unit 32 controls start and stop of supply of power to units 33 to 36 by power supply 31. Power supply control unit 32 is configured to include a switch for turning on and off conduction of electricity.

Communication interface 35 is an interface for communicating with gateway 20. Communication interface 36 is an interface for communicating with mobile phone 40. Operations of communication interfaces 35, 36 are controlled by communication control unit 334 of control unit 33.

Control unit 33 controls an overall operation of HeNB 30 based on programs and data stored in memory 34. Detection unit 331 detects the state of gateway 20. For example, detection unit 331 detects that gateway 20 has a fault. Specifically, detection unit 331 detects that communication with gateway 20 becomes impossible. When detection unit 331 detects that communication with gateway 20 becomes impossible, process performing unit 332 performs the predetermined process described above, for example, immediately after the detection.

Further, control unit 33 also detects that communication with gateway 20 is restored. When control unit 33 detects that communication with gateway 20 is restored, control unit 33 performs a process described below. If communication interfaces 35, 36 (transmission/reception units) of HeNB 30 are powered off, control unit 33 powers on communication interfaces 35, 36. If only transmission radio waves of HeNB 30 are turned off, control unit 33 turns on the transmission radio waves. If HeNB 30 is in an operation mode in which access of a mobile station to the HeNB is barred (i.e., barred setting), control unit 33 switches the operation mode to an operation mode in which access of the mobile station to the HeNB is allowed (i.e., cancels the barred setting).

Communication control unit 334 stops communication with mobile phone 40 in accordance with the state of gateway 20, which will be described in detail later.

It is noted that, processes performed by HeNB 30 other than those described above will be described later as appropriate.

FIG. 3 is a view showing determination criteria for determining that communication is impossible, process timings, and the contents of the predetermined process. FIG. 3(a) is a view showing determination criteria for determining that communication is impossible (determination criteria for a fault/congestion). FIG. 3(b) is a view showing timings to perform the contents of the process in FIG. 3(c). FIG. 3(c) is a view showing the contents of the predetermined process.

Referring to FIG. 3(a), HeNB 30 uses any of a criterion A, a criterion B, and a criterion C, as a determination criterion for detecting that communication with gateway 20 becomes impossible. Which criterion is to be used is preset in HeNB 30.

Referring to FIG. 3(b), when it is detected that communication with gateway 20 becomes impossible, HeNB 30 performs one of the contents of the process in FIG. 3(c) at timing a or timing b. Which timing is to be used is preset in HeNB 30.

It is noted that the timing to be used does not have to be preset in HeNB 30. For example, HeNB 30 may be configured such that setting of the timing is dynamically changed. The setting of the timing can be dynamically changed in the following two exemplary manners.

As a first manner, HeNB 30 uses timing based on an instruction from a higher apparatus. As a second manner, HeNB 30 automatically switches timing to be used among a plurality of preset timings. The second manner proceeds, for example, from “Restart HeNB 30”, “no improvement”, “Restart HeNB 30”, “no improvement”, to “Switch to the barred setting (i.e., Bar access)”.

Referring to FIG. 3(c), HeNB 30 performs any of a process α, a process β, a process γ, and a process δ, as the predetermined process described above, at the timing shown in FIG. 3(b).

Hereinafter, a case where criterion A is used as the determination criterion will be firstly described. Then, a case where criterion B is used as the determination criterion will be described. Finally, a case where criterion C is used as the determination criterion will be described.

### 2-1. Example in which Criterion a is Used

Hereinafter, a description will be given on the assumption that timing a (see FIG. 3(b)) is set as timing to perform one of the contents of the process in FIG. 3(c), for convenience of description.

(1. Case where Process α is Performed)

A case where HeNB 30 performs process α will be described. When HeNB 30 cannot receive a signal transmitted from gateway 20 at cycle Ta within a time longer than cycle Ta, HeNB 30 determines that communication with gateway 20 becomes impossible. When HeNB 30 determines that communication with gateway 20 becomes impossible, HeNB 30 powers off the main body of HeNB 30 immediately after the detection. More specifically, process performing unit 332 causes power supply control unit 32 to stop supply of power to control unit 33 by power supply 31.

Accordingly, mobile phone 40 within the coverage of HeNB 30 cannot communicate with HeNB 30. Thus, mobile phone 40 searches for a cell adjacent to a cell formed by HeNB 30. Therefore, HeNB 30 can cause mobile phone 40 to be handed over to another communicable base station.

(2. Case where Process β is Performed)

A case where HeNB 30 performs process β will be described. When HeNB 30 determines that communication with gateway 20 becomes impossible based on criterion A, HeNB 30 powers off communication interface 36 immediately after the determination (i.e., immediately after the detection). More specifically, process performing unit 332 causes power supply control unit 32 to stop supply of power to communication interface 36 by power supply 31.

Accordingly, mobile phone 40 within the coverage of HeNB 30 cannot communicate with HeNB 30. Thus, mobile phone 40 searches for a cell adjacent to the cell formed by HeNB 30. Therefore, HeNB 30 can cause mobile phone 40 to be handed over to another communicable base station.

In the case where process β is performed, power supply 31 continues supplying power to control unit 33 and communication interface 35. Thus, when control unit 33 detects that communication with gateway 20 is restored, control unit 33 preferably instructs power supply control unit 32 to resume supply of power to communication interface 36. With this configuration, the number of handovers can be further decreased, when compared with a configuration in which such an instruction is not provided.

(3. Case where Process γ is Performed)

A case where HeNB 30 performs process γ will be described. When HeNB 30 determines that communication with gateway 20 becomes impossible based on criterion A, HeNB 30 causes communication interface 36 to stop transmission of a signal to mobile phone 40 immediately after the determination (i.e., immediately after the detection). More specifically, process performing unit 332 causes communication interface 36 to stop transmission of a signal to mobile phone 40.

Accordingly, mobile phone 40 cannot communicate with HeNB 30. Thus, HeNB 30 can cause mobile phone 40 to be handed over to another communicable base station.

In the case where process γ is performed, when control unit 33 detects that communication with gateway 20 is restored, control unit 33 preferably instructs communication interface 36 to resume transmission of a signal to mobile phone 40. With this configuration, the number of handovers can be further decreased, when compared with a configuration in which such an instruction is not provided. Further, even in the case where process γ is performed, HeNB 30 can receive a signal transmitted from mobile phone 40. Thus, if HeNB 30 is configured to be able to accept a remote operation from mobile phone 40, a user of mobile phone 40 can instruct HeNB 30 to resume transmission of a signal to mobile phone 40.

(4. Case where Process δ is Performed)

A case where HeNB 30 performs process δ will be described. When HeNB 30 determines that communication with gateway 20 becomes impossible based on criterion A, HeNB 30 restarts immediately after the determination (i.e., immediately after the detection). More specifically, process performing unit 332 instructs power supply control unit 32 to perform a process of temporarily stopping supply of power from power supply 31 to control unit 33, and thereafter resuming supply of power.

Accordingly, mobile phone 40 cannot communicate with HeNB 30 temporarily. Thus, HeNB 30 can cause mobile phone 40 to be handed over to another communicable base station.

In the case where process δ is performed, when gateway 20 is restored, mobile phone 40 can be promptly handed over to HeNB 30.

Further, when the failure in communication with gateway 20 (including congestion) is due to connection between gateway 20 and HeNB 30 (such as mismatched states), HeNB 30 can restore communication with gateway 20. Here, merits of each of processes α, β, γ, and δ over other processes will be described.

Merit of Process α

Mobile phone 40 can move to another cell and communicate.

Merits of Process β

In addition to the merit of process α, process β has the following merit. Since the main body of HeNB 30 is powered on, when gateway 20 is restored, a restoration detection unit of HeNB 30 itself detects the restoration of gateway 20, and then communication interfaces 35, 36 can be automatically turned on.

Merits of Process γ

In addition to the merit of process α and the merit of process β, process γ has the following merit. By automatically turning on communication interfaces 35, 36, HeNB 30 can receive data from mobile phone 40. Thus, the user can turn on HeNB 30 by a remote operation from mobile phone 40.

Merits of Process δ

In addition to the merit of process α, process δ has the following merit. When the fault/congestion of gateway 20 is due to connection between gateway 20 and HeNB 30 (such as mismatched states), HeNB 30 can restore gateway 20. In this case, HeNB 30 may turn off communication interfaces 35, 36 until it confirms the restoration. Further, when gateway 20 is restored, HeNB 30 is in a normal state and thus mobile phone 40 can return to HeNB 30 promptly. It is noted that, when gateway 20 is not restored even after the restart, the process shifts to the process in which criterion A, timing a, and process α are combined, the process in which criterion A, timing a, and process β are combined, or the process in which criterion A, timing a, and process γ are combined.

It is noted that “congestion” refers to a state in which a large amount of traffic occurs on a network and it becomes difficult to perform normal transmission and reception. For example, when communication system 1 is a system in compliance with the standard “3GPP TS 36.314 V10.0.0 (2010-12)”, whether or not congestion occurs is determined in L2 measurement, based on items such as a load on gateway 20, the number of active mobile stations (UE), packet delay, data loss, and IP throughput.

Further, after the restart, HeNB 30 may stop supply of power to communication interface 36 until communication with gateway 20 is restored.

Furthermore, the HeNB is preferably configured to perform any of process α, process β, and process γ described above when communication with gateway 20 is not restored even after the restart.

(5. Modification)

It has been assumed that timing a (see FIG. 3(b)) is set as timing to perform any of processes α to δ described above. That is, a description has been given of an exemplary configuration in which, when HeNB 30 detects that communication with gateway 20 is impossible, HeNB 30 performs any of processes α to δ immediately after the detection.

However, the timing to perform any of the processes is not limited to timing a. HeNB 30 may use timing b shown in FIG. 3(b) as the timing. That is, HeNB 30 may be configured such that, when HeNB 30 detects that communication with gateway 20 is impossible, HeNB 30 performs any of processes α to δ after a predetermined time Td has passed since the detection that communication with gateway 20 becomes impossible. It is noted that, in the case of such a configuration, HeNB 30 adjusts the timing to perform the process, using the timer described above.

Also in a case where timing b is set, HeNB 30 exhibits the same effect as that described for each of processes α, β, γ, and δ in the case where timing a is set. Further, timing b is effective when the failure in communication with gateway 20 is restored in a short time. This is because HeNB 30 does not perform any of processes α to δ even if HeNB 30 falsely detects, for example, a short-time fault or congestion (for example, instantaneous power failure).

It is noted that, in the protocol for mobile phone 40, a timer for determining an error (such as no response) is often started by performing a certain operation. Thus, using timing b has an advantage that an operation intended for the timer can be implemented.

### 2-2. Example in which Criterion B is Used

Next, the case where criterion B is used as the determination criterion will be described. In this case, if HeNB 30 cannot receive from gateway 20 the response signal to the request signal transmitted to gateway 20 within a predetermined time Tc since the transmission of the request signal, HeNB 30 determines that communication with gateway 20 becomes impossible.

When HeNB 30 determines that communication with gateway 20 becomes impossible, HeNB 30 performs any of processes α to δ immediately after the detection (i.e., at timing a) or after time Td has passed since the detection (i.e., at timing b). It is noted that whether timing a is to be used or timing b is to be used is predetermined in HeNB 30. Further, which of process α, process β, process γ, and process δ is to be performed is also predetermined in HeNB 30.

Also in the case where HeNB 30 uses criterion B, the same effect as that described for each of processes α, β, γ, and δ in the case of using criterion A can be obtained. That is, at least the effect that “mobile phone 40 can move to another cell and thereby communicate” is obtained.

### 2-3. Example in which Criterion C is Used

Next, the case where criterion C is used as the determination criterion will be described. In this case, if HeNB 30 receives from gateway 20 a signal indicating that gateway 20 is uncommunicable, HeNB 30 determines that communication with gateway 20 becomes impossible.

When HeNB 30 determines that communication with gateway 20 becomes impossible, HeNB 30 performs any of processes α to δ immediately after the detection (i.e., at timing a) or after time Td has passed since the detection (i.e., at timing b). It is noted that whether timing a is to be used or timing b is to be used is predetermined in HeNB 30. Further, which of process α, process β, process γ, and process δ is to be performed is also predetermined in HeNB 30. It is noted that criteria A, B, and C represent determination criteria for a fault/congestion. Using criteria A, B, and C has a merit that “a fault/congestion can be determined” based on any of criteria A, B, and C.

Also in the case where HeNB 30 uses criterion C, the same effect as that described for each of processes α, β, γ, and δ in the case of using criterion A can be obtained. That is, at least the effect that “mobile phone 40 can move to another cell and thereby communicate” is obtained.

### 3. Control Structure

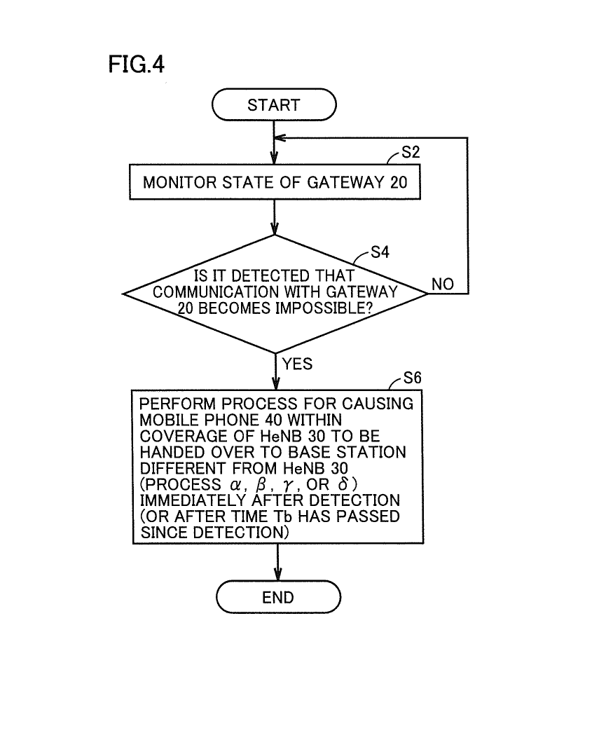

FIG. 4 is a flowchart illustrating a flow of the process of HeNB 30. Referring to FIG. 4, in step S2, control unit 33 of HeNB 30 monitors the state of gateway 20 using communication interface 35. In step S4, control unit 33 determines whether or not detection unit 331 detects that communication with gateway 20 becomes impossible.

When control unit 33 determines that detection unit 331 detects that the communication becomes impossible (YES in step S4), in step S6, control unit 33 performs the process for causing mobile phone 40 within the coverage of HeNB 30 to be handed over to a base station different from HeNB 30 (i.e., process α, process γ, process γ, or process δ) immediately after the detection or after predetermined time Td has passed since the detection. On the other hand, when control unit 33 determines that detection unit 331 does not detect that the communication becomes impossible, control unit 33 advances the process to step S2.

### 4. Hardware Configuration of Indoor Base Station

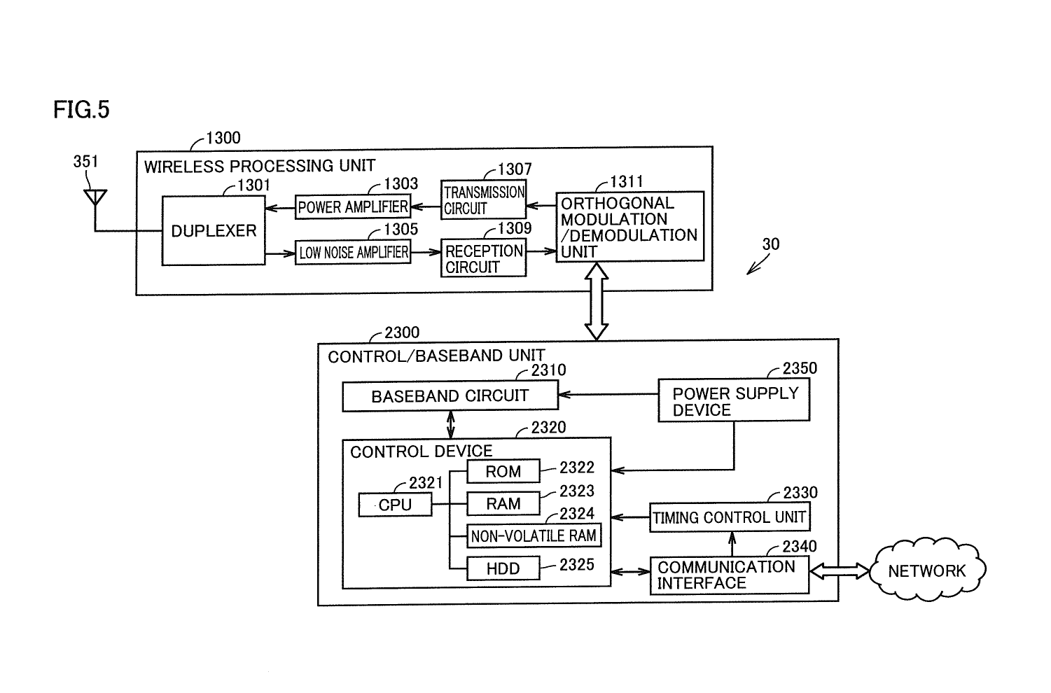

FIG. 5 is a view showing a typical hardware configuration of HeNB 30. Referring to FIG. 5, HeNB 30 includes an antenna 351, a wireless processing unit 1300, and a control/baseband unit 2300.

Each wireless processing unit 1300 includes a duplexer 1301, a power amplifier 1303, a low noise amplifier 1305, a transmission circuit 1307, a reception circuit 1309, and an orthogonal modulation/demodulation unit 1310. Control/baseband unit 2300 includes a baseband circuit 2310, a control device 2320, a power supply device 2350, a timing control unit 2330, and a communication interface 2340. Control device 2320 includes a CPU 2321, a ROM 2322, a RAM 2323, a non-volatile memory 2324, and an HDD (Hard Disk Drive) 2325.

Orthogonal modulation/demodulation unit 1311 performs orthogonal modulation/demodulation on an OFDM (Orthogonal Frequency Division Multiplexing) signal processed by baseband circuit 2310, and converts the OFDM signal into an analog signal (RF (Radio Frequency) signal). Transmission circuit 1307 converts the RF signal generated by orthogonal modulation/demodulation unit 1311 to have a frequency to be transmitted as a radio wave. Reception circuit 1309 converts a received radio wave to have a frequency to be processed by orthogonal modulation/demodulation unit 1311.

Power amplifier 1303 performs power amplification on the RF signal generated by transmission circuit 1307 to be transmitted from antenna 351. Low noise amplifier 1305 amplifies a weak radio wave received by antenna 351 and passes it to reception circuit 1309.

Control device 2320 controls entire HeNB 30, performs a protocol for call control, and performs monitoring of the call control. Timing control unit 2330 generates various clocks to be used within HeNB 30, based on a reference clock extracted from a transmission path and the like.

Communication interface 2340 connects a transmission path such as Ethernet (registered trademark), processes a protocol such as IPsec (Security Architecture for Internet Protocol) and IPv6 (Internet Protocol Version 6), and transmits/receives IP packets.

Baseband circuit 2310 performs conversion (modulation/demodulation) of the IP packets transmitted/received using communication interface 2340 into the OFDM signal (baseband signal) to be transmitted wirelessly. Further, the baseband signal is transmitted/received to/from wireless processing unit 1300.

Power supply device 2350 converts a voltage supplied to HeNB 30 into a voltage to be used within HeNB 30. Power supply device 2350 is composed of power supply 31 and power supply control unit 32 (see FIG. 2).

The process in HeNB 30 is implemented by each hardware and software executed by CPU 2321. Such software may be prestored in HDD 2325 or the like. Further, the software may be stored in a memory card (not shown) or another storage medium and distributed as a program product. Alternatively, the software may be provided by an information provider connected to so-called the Internet, as a downloadable program product. Such software is read from the storage medium by an IC card reader/writer or another reader, or downloaded through communication interface 2340, and thereafter temporarily stored in HDD 2325. The software is read from HDD 2325 by CPU 2321, and further stored in non-volatile memory 2324 in the form of an executable program. CPU 2321 executes the program.

Components constituting HeNB 30 shown in FIG. 5 are commonly used components. Accordingly, it can also be said that the essential part of the present invention is the software stored in HDD 2325, non-volatile memory 2324, the memory card or another storage medium, or the software which is downloadable through a network. It is noted that, since the operation of each hardware of HeNB 30 is well known, a detailed description thereof will not be repeated.

It is noted that the recording medium is not limited to a DVD-ROM, a CD-ROM, an FD (Flexible Disk), or a hard disk, and may be a medium which fixedly carries a program such as a magnetic tape, a cassette tape, an optical disk (MO (Magnetic Optical Disc)/MD (Mini Disc)/DVD (Digital Versatile Disc)), an optical card, and a semiconductor memory such as a mask ROM, an EPROM (Electronically Programmable Read-Only Memory), an EEPROM (Electronically Erasable Programmable Read-Only Memory), and a flash ROM. Further, the recording medium is a non-transitory computer-readable medium.

The program used herein includes not only a program which can be directly executed by a CPU, but also a program in the form of a source program, a compressed program, an encrypted program, and the like.

### Embodiment 2

In Embodiment 1, HeNB 30 performs any of processes α to δ after detecting that communication with gateway 20 becomes impossible, and thereby causes mobile phone 40 to be handed over to another base station. In the present embodiment, a description will be given of a configuration in which HeNB 30 transmits a command to instruct each mobile station (including mobile phone 40) to be handed over to another base station after detecting that communication with gateway 20 becomes impossible. More specifically, a description will be given of a configuration of HeNB 30 for preventing each mobile station from being handed over again to HeNB 30 under the control of uncommunicable gateway 20, after HeNB 30 provides each mobile station with the instruction for handover. It is noted that the HeNB will be hereinafter designated by a reference numeral “30A” to be distinguished from HeNB 30 in Embodiment 1, for convenience of description.

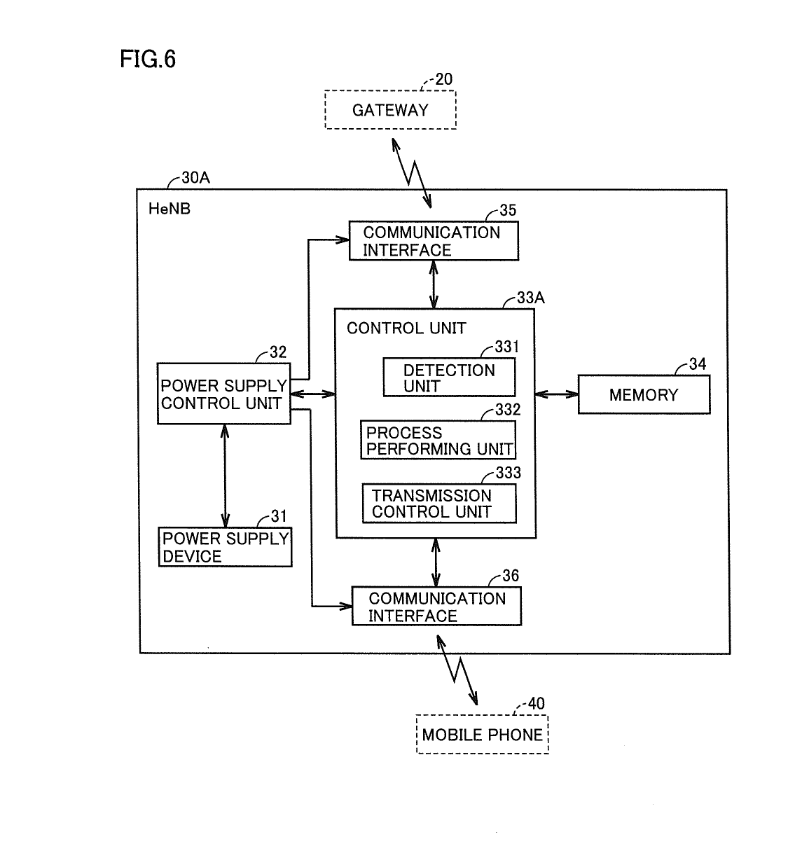

FIG. 6 is a functional block diagram of an HeNB 30A. Referring to FIG. 6, HeNB 30A includes power supply 31, power supply control unit 32, a control unit 33A, memory 34, communication interface 35, communication interface 36, and a timer not shown. Control unit 33A includes detection unit 331, process performing unit 332, and a transmission control unit 333.

When a fault of gateway 20 is detected, transmission control unit 333 transmits a command to cause mobile phone 40 to be handed over to an HeNB which is not under the control of gateway 20, to mobile phone 40. Specifically, when detection unit 331 detects that communication with gateway 20 becomes impossible, transmission control unit 333 transmits a command to cause mobile phone 40 within a coverage of HeNB 30 to be handed over to a base station different from HeNB 30, to mobile phone 40, using communication interface 36. The command is specifically such as “Move to a base station having the highest sensitivity”. In this case, a specific base station is designated. It is noted that the command is generally the same as an instruction for handover provided while moving by car or the like.

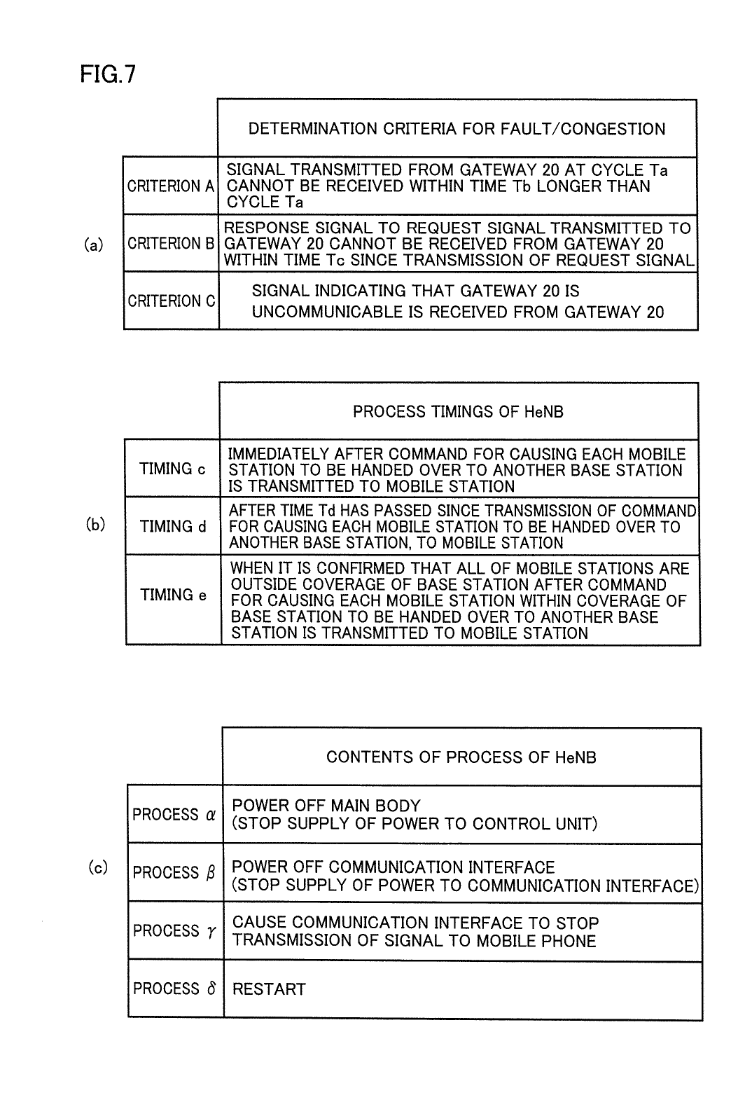

After the command is transmitted, process performing unit 332 performs a predetermined process for preventing mobile phone 40 from entering the coverage of HeNB 30 again, at predetermined timing. It is noted that the “predetermined timing” will be described later (FIG. 7(b)). Further, the “predetermined process” will also be described later (FIG. 7(c)).

FIG. 7 is a view showing determination criteria for determining that communication is impossible, process timings, and contents of the predetermined process. FIG. 7(a) is a view showing determination criteria for determining that communication is impossible (determination criteria for a fault/congestion). FIG. 7(b) is a view showing timings to perform the contents of the process in FIG. 7(c). FIG. 7(c) is a view showing the contents of the predetermined process.

Referring to FIG. 7(a), the determination criteria are the same as the determination criteria shown in FIG. 3(a) in Embodiment 1. Thus, a description of criteria A to C shown in FIG. 7(a) will not be repeated here.

Referring to FIG. 7(c), the contents of the process are the same as the contents of the process shown in FIG. 3(c) in Embodiment 1. Thus, a description of processes α to δ shown in FIG. 7(c) will not be repeated here.

Referring to FIG. 7(b), only timings to perform any of processes α to δ are different from the timings (i.e., timing a, timing b) shown in FIG. 3(b) in Embodiment 1. Accordingly, an operation of HeNB 30A will be described below, with a focus on the three timings shown in FIG. 7(b).

It is noted that which of criterion A, criterion B, and criterion C is to be used as a determination criterion that communication with gateway 20 is impossible is predetermined in HeNB 30A. Further, which of timing c, timing d, and timing e is to be used is predetermined in HeNB 30A. Furthermore, which of process α, process β, process γ, and process δ is to be performed is also predetermined in HeNB 30A.

(1. Timing c)

When detection unit 331 detects that communication with gateway 20 is impossible based on one predetermined criterion among criteria A to C, transmission control unit 333 transmits, to each mobile station (including mobile phone 40) within the coverage of HeNB 030A, a command to cause the mobile station to be handed over to another base station, using communication interface 36. Immediately after the command is transmitted, process performing unit 332 performs one predetermined process among processes α to δ.

Since any of processes α to γ is performed after the handover, the mobile station cannot communicate with HeNB 30. Thus, the mobile station cannot return to original HeNB 30. Further, when process δ is performed after the handover, the mobile station cannot return to original HeNB 30 during the restart, but may return to original HeNB 30 after the restart. Furthermore, also when HeNB 30 is in an operation mode in which access of the mobile station to the HeNB is barred (i.e., barred setting), the mobile station does not return to original HeNB 30.

It is noted that, when communication with gateway 20 can be promptly restored, HeNB 30 may be caused to perform process δ (i.e., restart) in order to return the mobile station to the original base station instead of another base station.

In this case, the same effect as that described for each of processes α, β, γ, and δ in the case of using each of criteria A, B, and C can be obtained. More precisely, the same effect as that obtained by one of 12 combinations described in Embodiment 1 (specifically, combinations each including one of criteria A to C, timing a, and one of processes α to δ) can be obtained.

Further, since HeNB 30A provides mobile phone 40 with an instruction for handover, power consumption of mobile phone 40 can be reduced, when compared with a configuration in which an instruction for handover is not provided.

(2. Timing d)

When detection unit 331 detects that communication with gateway 20 is impossible based on one predetermined criterion among criteria A to C, transmission control unit 333 transmits, to each mobile station (including mobile phone 40) within the coverage of HeNB 030A, a command to cause the mobile station to be handed over to another base station, using communication interface 36. After predetermined time Td has passed since the transmission of the command, process performing unit 332 performs one predetermined process among processes α to δ.

Also in this case, the same effect as that described for each of processes α, β, γ, and δ in the case of using each of criteria A, B, and C can be obtained. More precisely, the same effect as that obtained by one of 12 combinations described in Embodiment 1 (specifically, combinations each including one of criteria A to C, timing b, and one of processes α to δ) can be obtained.

Further, since HeNB 30A provides mobile phone 40 with an instruction for handover, power consumption of mobile phone 40 can be reduced, when compared with a configuration in which an instruction for handover is not provided.

(3. Timing e)

When detection unit 331 detects that communication with gateway 20 is impossible based on one predetermined criterion among criteria A to C, transmission control unit 333 transmits, to each mobile station (including mobile phone 40) within the coverage of HeNB 030A, a command to cause the mobile station to be handed over to another base station, using communication interface 36. When process performing unit 332 confirms that all of the mobile stations are outside the coverage of HeNB 30A in accordance with the command, process performing unit 332 performs one predetermined process among processes α to δ.

Also in this case, the same effect as that described for each of processes α, β, γ, and δ in the case of using each of criteria A, B, and C can be obtained. Further, since HeNB 30A performs one predetermined process among processes α to δ after it confirms that the mobile stations have been handed over, HeNB 30A can be prevented from performing the one predetermined process with the mobile stations remaining within the coverage of HeNB 30A.

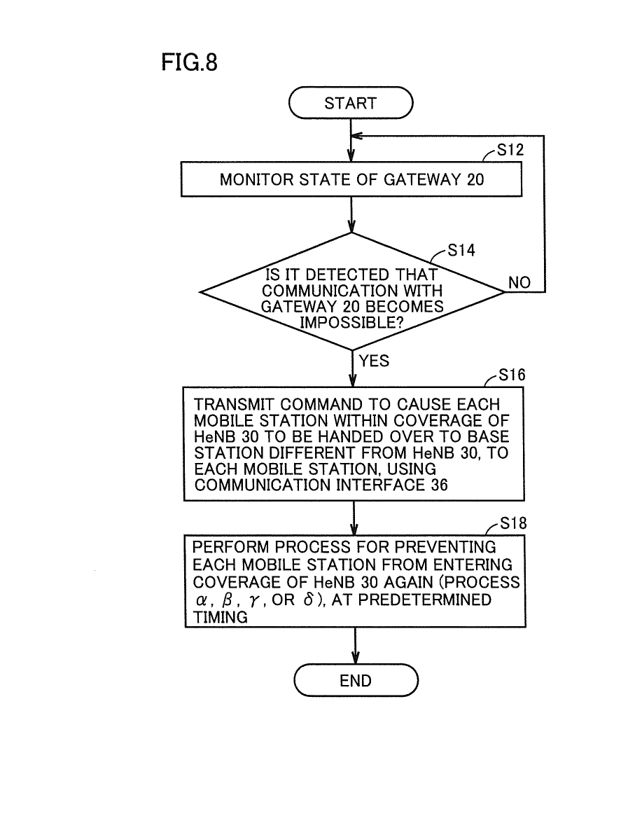

FIG. 8 is a flowchart illustrating a flow of the process of HeNB 30A. Referring to FIG. 8, in step S12, control unit 33A of HeNB 30A monitors the state of gateway 20 using communication interface 35. In step S14, control unit 33A determines whether or not detection unit 331 detects that communication with gateway 20 becomes impossible.

When control unit 33A determines that detection unit 331 detects that the communication becomes impossible (YES in step S14), in step S16, control unit 33A transmits a command to cause each mobile station within the coverage of HeNB 30A to be handed over to a base station different from HeNB 30A, to the each mobile station, using communication interface 36. On the other hand, when control unit 33 determines that detection unit 331 does not detect that the communication becomes impossible, control unit 33 advances the process to step S12.

In step S18, control unit 33A performs the process for preventing the mobile station from entering the coverage of HeNB 30A again (i.e., process α, process β, process γ, or process δ), at predetermined timing (i.e., any of timings c to e).

### Embodiment 3

In the present embodiment, a description will be given of a configuration in which an HeNB switches an operation mode between an operation mode in which access of a mobile station to the HeNB is allowed and an operation mode in which access of the mobile station to the HeNB is barred (i.e., barred setting). It is noted that, when the barred setting is canceled, the operation mode is switched to the operation mode in which access to the HeNB is allowed. Further, the HeNB will be hereinafter designated by a reference numeral “30B” to be distinguished from HeNB 30, 30A in Embodiment 1, for convenience of description.

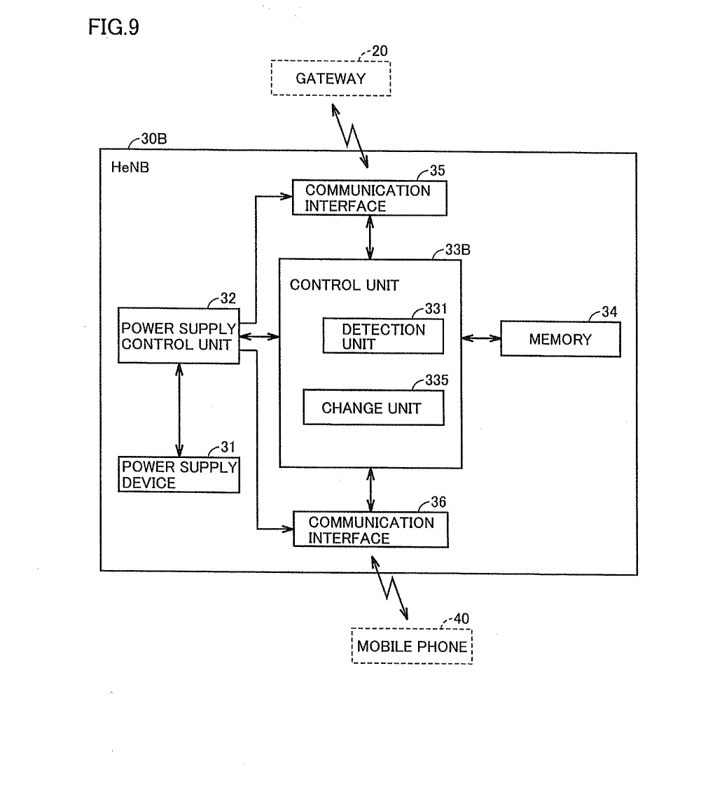

FIG. 9 is a functional block diagram of an HeNB 30B. Referring to FIG. 9, HeNB 30B includes power supply 31, power supply control unit 32, a control unit 33B, memory 34, communication interface 35, communication interface 36, and a timer not shown. Control unit 33B includes detection unit 331, and a change unit 334.

When detection unit 331 detects that communication with gateway 20 becomes impossible, change unit 334 changes an operation mode of HeNB 30B from a setting in which access is allowed to a setting in which access is barred (i.e., barred setting). Due to the barred setting, the mobile station cannot access a base station for which restriction information that access is not allowed (i.e., cell barred) is set in information to be notified.

When HeNB 30B is changed to the barred setting, mobile phone 40 within a coverage of HeNB 30 cannot communicate with HeNB 30. Thus, mobile phone 40 searches for a cell adjacent to a cell formed by HeNB 30. Therefore, HeNB 30 can cause mobile phone 40 to be handed over to another communicable base station.

Further, unless the barred setting is canceled, mobile phone 40 does not enter the coverage of HeNB 30B again without performing the processes such as powering off the main body of HeNB 30B (processes α to δ).

Furthermore, by canceling the barred setting when HeNB 30B restores communication with gateway 20, mobile phone 40 can enter the coverage of HeNB 30B again.

### Embodiment 4

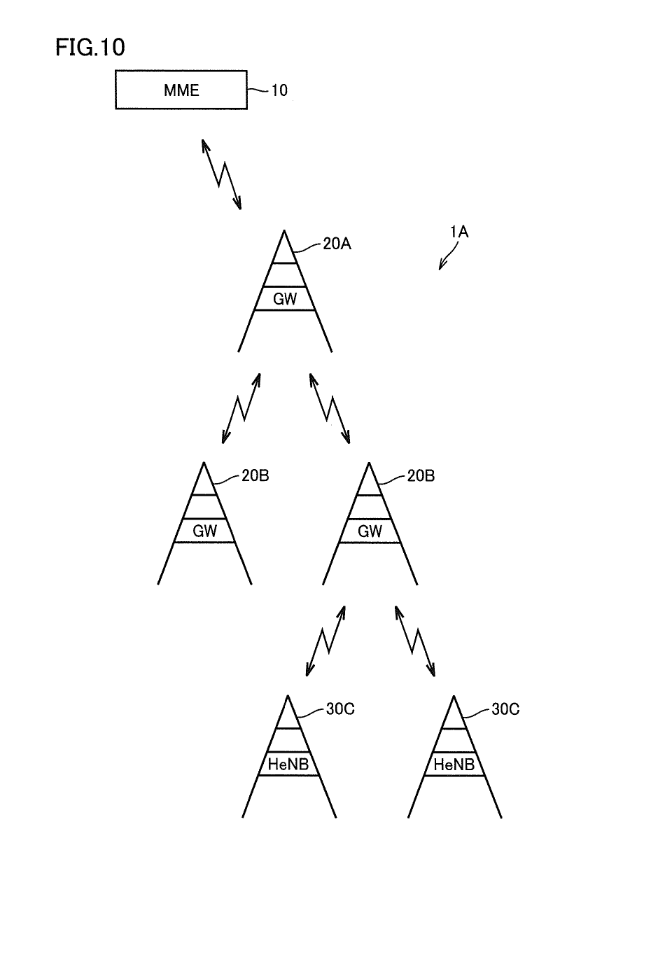

FIG. 10 is a view showing a configuration of a communication system 1A in accordance with the present embodiment. Referring to FIG. 10, communication system 1A includes MME 10, a gateway 20A, two gateways 20B, and a plurality of HeNBs 30C.

Gateway 20A communicates with MME 10. Further, gateway 20A communicates with two gateways 20B. That is, gateway 20A relays communication between MME 10 and two gateways 20B. It is noted that gateway 20A has the same hardware configuration as that of gateway 20.

Each gateway 20B communicates with gateway 20A. Further, each gateway 20B communicates with one or more HeNBs 30C. That is, each gateway 20B relays communication between gateway 20A and HeNBs 30C. It is noted that gateway 20A has the same hardware configuration as that of gateway 20.

HeNB 30C has the same hardware configuration as that of HeNB 30, HeNB 30A. However, HeNB 30C does not have to include detection unit 331, process performing unit 332, and transmission control unit 333 described above.

In communication system 1A, each gateway 20B performs one of processes α to δ, at one of timings a to e, using one of determination criteria A to C shown in FIGS. 3 and 7, instead of HeNB 30, 30A.

More specifically, when gateway 20B is described as an example corresponding to Embodiment 1, the following description will be given. Gateway 20B communicates with MME 10 through a relay process by another gateway 20A. Gateway 20B includes a detection unit (not shown) detecting that communication with other gateway 20A becomes impossible. Further, gateway 20B includes a process performing unit (not shown) performing, when it is detected that the communication becomes impossible, a predetermined process for causing a mobile station within a coverage of HeNB 30C communicably connected to gateway 20B to be handed over to a base station different from HeNB 30C (that is, process α, β, γ, or δ) immediately after the detection or after a predetermined time has passed since the detection.

Here, when gateway 20B detects a fault of gateway 20A, gateway 20B performs a process of blocking communication with HeNB 30C (i.e., any of processes α to δ). In this case, HeNB 30C which fails to communicate with gateway 20B provides the mobile station with an instruction to cause the mobile station to be handed over to another communicable cell.

Further, when gateway 20B is described as an example corresponding to Embodiment 2, the following description will be given. Gateway 20B communicates with MME 10 through a relay process by another gateway 20A. Gateway 20B includes a detection unit (not shown) detecting that communication with other gateway 20A becomes impossible. Further, gateway 20B includes a transmission control unit (not shown) transmitting, when it is detected that the communication becomes impossible, a command for causing a mobile station within the coverage of HeNB 30C communicably connected to gateway 20B to be handed over to a base station different from HeNB 30C, to the mobile station, via HeNB 30C. Furthermore, gateway 20B includes a process performing unit (not shown) performing a predetermined process for preventing the mobile station from entering the coverage of HeNB 30C again (that is, process α, β, γ, or δ), at predetermined timing (that is, timing c, d, or e) after transmission of the command.

Also by configuring communication system 1A as described above, the mobile station within the coverage of HeNB 30C can be handed over to another communicable base station.

<Additional Notes>

(1) A base station communicating with an entity performing mobility management through a relay process by a gateway, comprising:

detection means detecting that communication with said gateway becomes impossible; and

performing means performing, when it is detected that said communication becomes impossible, a predetermined process for causing a mobile station within a coverage of said base station to be handed over to a base station different from said base station, immediately after the detection or after a predetermined time has passed since the detection.

(2) A base station communicating with an entity performing mobility management through a relay process by a gateway, comprising:

detection means detecting that communication with said gateway becomes impossible;

transmission control means transmitting, when it is detected that said communication becomes impossible, a command for causing a mobile station within a coverage of said base station to be handed over to a base station different from said base station, to said mobile station, using a communication interface; and

performing means performing a predetermined process for preventing said mobile station from entering the coverage of said base station again, at predetermined timing after transmission of said command.

(3) The base station according to (2), wherein said predetermined timing is immediately after the transmission of said command, after a predetermined time has passed since the transmission of said command, or when it is confirmed that no mobile station is within the coverage of said base station after the transmission of said command.

(4) The base station according to any of (1) to (3), wherein said detection means determines that the communication with said gateway becomes impossible, in a case where a signal transmitted from said gateway at a predetermined cycle cannot be received within a predetermined time longer than said cycle, in a case where a response signal to a request signal transmitted to said gateway cannot be received from the gateway within a predetermined time since transmission of the request signal, or in a case where a signal indicating that said gateway is uncommunicable is received from the gateway.

(5) The base station according to any of (1) to (4), further comprising:

control means including at least said detection means and said performing means, and controlling an operation of said base station;

a power supply; and

power supply control means controlling start and stop of supply of power to said control means by said power supply,

wherein said performing means causes said power supply control means to stop said supply of power, as said predetermined process.

(6) The base station according to any of (1) to (4), further comprising:

a power supply;

a communication interface for communicating with said mobile station; and

power supply control means controlling start and stop of supply of power to said communication interface by said power supply,

wherein said performing means causes said power supply control means to stop said supply of power, as said predetermined process.

(7) The base station according to any of (1) to (4), further comprising a communication interface for communicating with said mobile station,

wherein said performing means causes said communication interface to stop transmission of a signal to said mobile station, as said predetermined process.

(8) The base station according to any of (1) to (4), wherein said performing means restarts said base station, as said predetermined process.

(9) A base station communicating with an entity performing mobility management through a relay process by a gateway, comprising:

detection means detecting that communication with said gateway becomes impossible; and

change means changing an operation mode of said base station, when it is detected that said communication becomes impossible, from a setting in which access of said mobile station is allowed to a setting in which access of said mobile station is barred.

(10) A gateway communicating with an entity performing mobility management through a relay process by another gateway, comprising:

detection means detecting that communication with said other gateway becomes impossible; and

performing means performing, when it is detected that said communication becomes impossible, a predetermined process for causing a mobile station within a coverage of a base station communicably connected to said gateway to be handed over to a base station different from said base station, immediately after the detection or after a predetermined time has passed since the detection.

(11) A gateway communicating with an entity performing mobility management through a relay process by another gateway, comprising:

detection means detecting that communication with said other gateway becomes impossible;

transmission control means transmitting, when it is detected that said communication becomes impossible, a command for causing a mobile station within a coverage of a base station communicably connected to said gateway to be handed over to a base station different from said base station, to said mobile station, via said base station; and

performing means performing a predetermined process for preventing said mobile station from entering the coverage of said base station again, at predetermined timing after transmission of said command.

(12) A handover control method in a base station communicating with an entity performing mobility management through a relay process by a gateway, comprising the steps of:

said base station detecting that communication with said gateway becomes impossible; and

said base station performing, when it is detected that said communication becomes impossible, a predetermined process for causing a mobile station within a coverage of said base station to be handed over to a base station different from said base station, immediately after the detection or after a predetermined time has passed since the detection.

(13) A handover control method in a base station communicating with an entity performing mobility management through a relay process by a gateway, comprising the steps of:

said base station detecting that communication with said gateway becomes impossible;

said base station transmitting, when it is detected that said communication becomes impossible, a command for causing a mobile station within a coverage of said base station to be handed over to a base station different from said base station, to said mobile station, using a communication interface; and

said base station performing a predetermined process for preventing said mobile station from entering the coverage of said base station again, at predetermined timing after transmission of said command.

(14) A handover control method in a base station communicating with an entity performing mobility management through a relay process by a gateway, comprising the steps of

said base station detecting that communication with said gateway becomes impossible; and

said base station changing an operation mode of said base station, when it is detected that said communication becomes impossible, from a setting in which access of said mobile station is allowed to a setting in which access of said mobile station is barred.

(15) A handover control method in a gateway communicating with an entity performing mobility management through a relay process by another gateway, comprising the steps of:

said gateway detecting that communication with said other gateway becomes impossible; and

said gateway performing, when it is detected that said communication becomes impossible, a predetermined process for causing a mobile station within a coverage of a base station communicably connected to said gateway to be handed over to a base station different from said base station, immediately after the detection or after a predetermined time has passed since the detection.

(16) A handover control method in a gateway communicating with an entity performing mobility management through a relay process by another gateway, comprising the steps of:

said gateway detecting that communication with said other gateway becomes impossible;

said gateway transmitting, when it is detected that said communication becomes impossible, a command for causing a mobile station within a coverage of a base station communicably connected to said gateway to be handed over to a base station different from said base station, to said mobile station, via said base station; and

said gateway performing a predetermined process for preventing said mobile station from entering the coverage of said base station again, at predetermined timing after transmission of said command.

(17) A program for causing a computer to execute said handover control method.

The embodiments disclosed herein are merely illustrative, and should not be limited to the above description only. The scope of the present invention is defined by the scope of the claims, and is intended to include any modifications within the scope and meaning equivalent to the scope of the claims.

### REFERENCE SIGNS LIST

1, 1A: communication system; 20, 20A, 20B: gateway; 40: mobile phone; 30, 30A, 30B, 30C: HeNB; 31: power supply; 32: power supply control unit; 33, 33A, 33B: control unit; 35, 36, 2340: communication interface; 182, 2320: control device; 331: detection unit; 332: process performing unit; 333: transmission control unit; 334: change unit; 1300: wireless processing unit; 2321: CPU; 2300: baseband unit; 2310: baseband circuit; 2320: control device; 2330: timing control unit; 2350: power supply device.

1.-10. (canceled)

11. A base station communicating with an entity performing mobility management through a relay process by a gateway, comprising:
a detection unit configured to detect a state of said gateway, and determine that communication with said gateway becomes impossible in a case where a signal transmitted from said gateway at a predetermined cycle cannot be received within a predetermined time longer than said cycle, in a case where a response signal to a request signal transmitted to said gateway cannot be received from the gateway within a predetermined time since transmission of the request signal, or in a case where a signal indicating that said gateway is uncommunicable is received from the gateway; and
a communication control unit configured to cause at least one of a process of powering off part or all of components of said base station, a process of stopping transmission of a signal from said base station to a mobile station, and a process of restarting said base station, to be performed.

12. The base station according to claim 11, further comprising a change unit configured to change an operation mode of said base station from a setting in which access of said mobile station is allowed to a setting in which access of said mobile station is barred,
wherein, when it is determined that the communication with said gateway becomes impossible, said change unit changes the operation mode of said base station from the setting in which access of said mobile station is allowed to the setting in which access of said mobile station is barred.

13. The base station according to claim 11, wherein, when it is determined that the communication with said gateway becomes impossible, said base station transmits a command to cause said mobile station to be handed over to a base station which is not under control of said gateway, to said mobile station.

14. A control method in a base station communicating with an entity performing mobility management through a relay process by a gateway, comprising the steps of:
detecting a state of said gateway; and
determining that communication with said gateway becomes impossible in a case where a signal transmitted from said gateway at a predetermined cycle cannot be received within a predetermined time longer than said cycle, in a case where a response signal to a request signal transmitted to said gateway cannot be received from the gateway within a predetermined time since transmission of the request signal, or in a case where a signal indicating that said gateway is uncommunicable is received from the gateway.

15. The control method according to claim 14, further comprising the step of changing, when it is determined that the communication with said gateway becomes impossible, an operation mode of said base station from a setting in which access of a mobile station is allowed to a setting in which access of said mobile station is barred.

16. The control method according to claim 14, further comprising the step of causing at least one of a process of powering off part or all of components of said base station, a process of stopping transmission of a signal from said base station to a mobile station, and a process of restarting said base station, to be performed.

17. The control method according to claim 14, further comprising the step of transmitting, when it is determined that the communication with said gateway becomes impossible, a command to cause said mobile station to be handed over to a base station which is not under control of said gateway, to said mobile station.

18. A non-transitory computer-readable recording medium recording a program for controlling a base station communicating with an entity performing mobility management through a relay process by a gateway,
said program causing a processor of said base station to execute the steps of:
detecting a state of said gateway; and
determining that communication with said gateway becomes impossible in a case where a signal transmitted from said gateway at a predetermined cycle cannot be received within a predetermined time longer than said cycle, in a case where a response signal to a request signal transmitted to said gateway cannot be received from the gateway within a predetermined time since transmission of the request signal, or in a case where a signal indicating that said gateway is uncommunicable is received from the gateway.

19. The non-transitory computer-readable recording medium according to claim 18, wherein said program causes the processor of said base station to further execute the step of changing, when it is determined that the communication with said gateway becomes impossible, an operation mode of said base station from a setting in which access of a mobile station is allowed to a setting in which access of said mobile station is barred.

20. The non-transitory computer-readable recording medium according to claim 18, wherein said program causes the processor of said base station to further execute the step of causing at least one of a process of powering off part or all of components of said base station, a process of stopping transmission of a signal from said base station to a mobile station, and a process of restarting said base station, to be performed.

21. The non-transitory computer-readable recording medium according to claim 18, wherein said program causes the processor of said base station to further execute the step of transmitting, when it is determined that the communication with said gateway becomes impossible, a command to cause said mobile station to be handed over to a base station which is not under control of said gateway, to said mobile station.
